(19) United States
(12) Patent Application Publication
(10) Pub. No.: US 2005/0170148 A1
(43) Pub. Date: Aug. 4, 2005

(54) Method for manufacturing board and a board product

(76) Inventors: Jorma Mattila, Kangasala (FI); Kirsi Nissinen, Vilppula (FI); Hannu Mikkonen, Rajamaki (FI); Soili Peltonen, Rajamaki (FI)

Correspondence Address: KUBOVCIK & KUBOVCIK, SUITE 710, 900 17TH STREET NW, WASHINGTON, DC, 20006, US

(21) Appl. No.: 10/504,563

(22) PCT Filed: Feb. 17, 2003
(86) PCT No.: PCT/FI03/00117

(30) Foreign Application Priority Data
Feb. 15, 2002 (FI) 20020314

(51) Int. Cl. B32B 3/00

(52) U.S. Cl. 428/174; 156/209

(57) ABSTRACT

A method for manufacturing a board product made up of at least two layers, and a multilayer board product. According to the method, the board webs (4, 5, 6) forming the layers are bonded together by gluing. According to the invention, at least one of the webs is treated mechanically by compression so that in the web surface there form permanent deformations projecting from the web surface, and the layers are glued together by using a starch-based adhesive, which is applied at a solids content over 45% to the layers to be bonded. The adhesive having a high solids content dries and bonds rapidly to the surfaces to be joined, even without additional heating. Since the adhesive contains little or no water, no after-bending or flattening of the middle layer occurs in the bond.

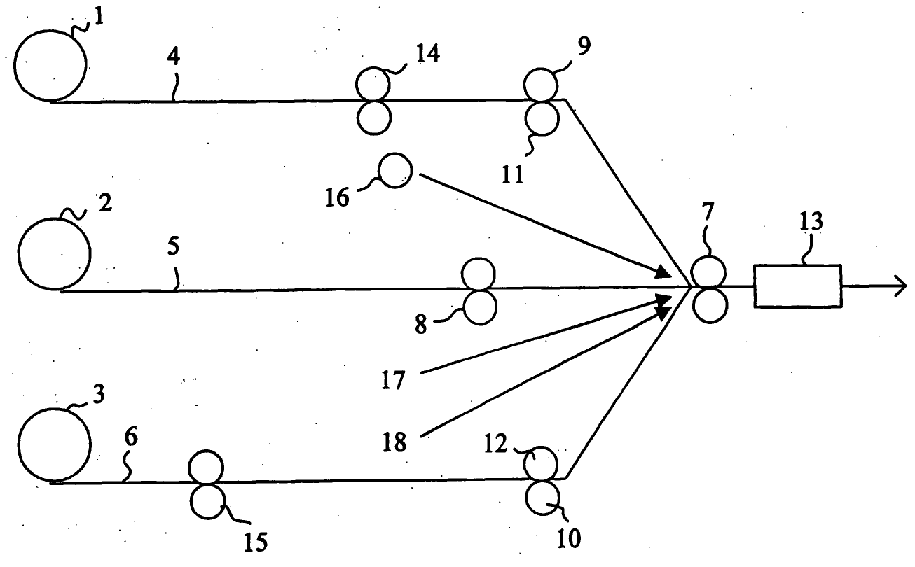

The present invention relates to the method according to the preamble of claim 1 for manufacturing multilayer paperboard.

The invention also relates to the board product according to the preamble of claim 13.

Paperboard is used as a printing substrate and to a high degree in various packages. Important properties of packaging boards include the strength, stiffness sand protective properties of the material and, if text or pictures axe to be printed on the surface of the package, a sufficiently high quality of the printing substrate.

In order for the paperboard to be sufficiently stiff, it must be sufficiently thick, and therefore a large amount of fibrous raw material is consumed for the manufacture of paperboard. On the other hand, the higher the requirements set on hie printing substrate, the more expensive the raw material required, for example, for achieving sufficient brightness of the product. Since the stiffness of paperboard depends most on its thickness, the consumption of material and the raw material costs increase almost directly as a function of the thickness and mass of the product. Therefore it would indeed be advantageous for the surface of paperboard to be of a strong and dense material having sufficiently good printing properties and for the inner part to have a low density. For this reason, as the stiffness requirement increases, corrugated boa is often preferred for the manufacture of packaging.

Corrugated board is a laminated product made up of two facings, or liners, and of a corrugated layer, fluting, between them. In multilayer boards there are several fluted middle layers, and a middle layer is separated by straight paperboard layers corresponding to the facings. The shape of the flutes, flute length and flute height may vary, but the fluting is always made transverse to the machine direction of the raw material web.

Even though corrugated board is an advantageous packaging material, it has several weaknesses. The compressive strength or board varies largely according to whether it is a flute crest or a valley that is subjected to compression, and likewise the liners are not always always planar; they may have deformations due to, for example, slight shrinkage after being glued. The properties of a liner of a board, of course, depend on the thickness and type of the liner board, but in general corrugated board is not regarded as being especially well suited for treatment by contact printing methods, a fact which limits its use in highest-quality packaging. Corrugated boards are usually also quite thick.

One drawback of corrugated board is its rather complicated manufacturing process. A corrugated board made up of three layers is manufactured by fluting the middle layer and by applying adhesive to the flute crests, whereafter it is pressed against the first liner. The second liner is then glued in a separate step to the formed two-layer half-finished product. Glue is applied only to the flute crests, and so the application can in principle be carried out only with a hard-surfaced applicator, such as a roll. By such an application method it is difficult to ensure complete bonding. The two-step manufacturing method is expensive, and the plant is long and large-sized, thus requiring a large amount of space in the mill and being expensive as an investment. If board with more layers is manufactured, there will be more steps according to the number of layers.

As a solution to problems associated with conventional technology, we disclosed in our previous FI patent application 20001799 an invention by means of which it is possible to manufacture board having high stiffness and a lower requirement of material in relation to stiffness than have previous board grades. According to the invention, the board is formed from at least two, preferably three, layers glued to one another, and before the gluing there are formed in the material of the middle layer, in a dry state, permanent deformations that project in free-form desired patterns from the surface of the material.

In our FI patent application 20001799 we have also disclosed a method for manufacturing such a novel board product.

The object of the present invention is to improve further the invention described in our previous application. It is a particular object of the present invention to provide an option suited for the gluing of the novel board product.

The invention is based on the idea that a board product made up of at least two layers is manufactured by treating at least one of the webs mechanically by compression so that on the surface of the web there form permanent deformations projecting from the web surface, and by gluing the layers together by using a starch-based adhesive that is applied at a high solids content to the layers to be glued together.

In the present invention, water-based starch-derivative dispersion adhesives, solution adhesives and hot-melt adhesives arm used. The adhesives are characterized by a high solids content and low viscosity.

The problem involved with commercially available adhesives in the manufacture of the board product according to the invention is that their viscosity at room temperature is too high, and from this follows poor spreadability. Furthermore, commercial dextrin adhesives have proved to involve the problem that upon drying they form a hard adhesive seam that opens when the board is folded. The glued sheets also tend to become detached at the edges at the cutting stage.

These problems can be avoided by using for the gluing a dispersion of a starch derivative or a solution adhesive or hot melt adhesive composition containing such a derivative. As starch derivatives are regarded conventional starch esters, starch ethers and mixed starch ester/ethers, cationized starch, and transglycosylation products of starch and of starch derivatives.

In the board product according to the invention, at least one of the layers has therefore been worked mechanically so that the material has permanent three-dimensional deformations, and at least two layers are bonded together with a starch-based adhesive that contains a starch derivative having a solids content of at least 45% and a viscosity sufficiently low in order that the adhesive can be spread into a continuous layer on the board surface by conventional techniques.

More precisely, the method according to the invention is characterized in what is stated in the characterizing part of claim 1.

The board product according to the invention is for its part characterized in what is stated in the characterizing part of claim 13.

Considerable advantages are achieved through the invention. Thus, by means of the invention it is possible to produce a high-quality printable packaging board in which the ratio of stiffness to the consumption of raw material, and in particular fibrous raw material, is considerably better than that in prior known board grades. The properties of the board are easy to vary, and even very light board grades can be manufactured from it. The bulk of the product is high, as are also its strength and stiffness relative to its grammage. The stiffness of the product is even better than that of corrugated board. On the other hand, in comparison with an equally stiff and strong product, less fiber stock is required for the manufacture of the board according to the invention. For this reason the manufacture of the board is more economical and its environmental load is less than that of conventional uniform-material board. The product is completely and easily recyclable if all of the layers of the product are made from plant fiber material and if starch-based adhesives are used for the gluing. If liquid or gas barriers are required in the product, they can be implemented easily by means of generally used films and gluing. In this case the recyclability of the product is determined by the film types used, and thus in terms of recyclability it is preferable to favor materials that are recyclable together with the fiber stock.

An adhesive having a high solids content dries and bonds to the surfaces to be bonded quickly even without additional heating. Since the adhesive contains little or no water, there occurs no after-bending or flattening of the middle layer during the gluing. Starch-based adhesives are light in color, and therefore they can be used for gluing low-opacity board layers without the color of the glue being visible in the end product.

The board can be manufactured in one single roll nip, and the adhesive can be spread in many ways, for example by spraying, application and pressing, and thus the bonding of the webs and the spreading of the adhesive are simple. At its most advantageous the product is immediately ready and does not require drying or storage; it can be directed immediately to further processing. Since the web forming the middle layer is processed mechanically by compression, without using heat, the processing apparatus is very simple. The invention can be applied to many types of materials, and thus the most economical raw material available at a given time can be used. This is an advantage, for example, when a high degree of brightness is not required of the product; in this case it is possible to use a more economical, less bleached fiber or recycled fiber that is not completely bleached. The strength properties of the product and its shielding properties and outer appearance can also be varied through the use of different adhesives. Dispersion adhesives, solution adhesives and hot melt adhesives were already mentioned above. With each, a slightly different bonding process and gluing result is attained. It is possible to use for the gluing, for example, a foam adhesive, which fills the cavities in the product, whereby its stiffness is substantially increased.

It should be pointed out that one or several of the layers forming the product may be of a polymer material or a metal foil, or one of the layers may be coated with a material that forms a film or a barrier layer (barrier film) of the desired type. Such boards are needed, for example, for liquid packaging or for packages impermeable or poorly permeable to moisture or gases, and for products to be heat-sealed. Of course, there may be several different films in one and the same product.

The invention is described below in greater detail with the help of the accompanying drawing, which depicts schematically one embodiment of the invention.

The embodiment shown in the FIGURE is intended for the manufacture of a product made up of three layers. For the manufacture of a three-layer product there are needed three webs 4, 5, 6, which are introduced into the manufacturing process by means of rolls 1, 2, 3. From the rolls 1, 2, 3, the required quantities of the webs are unwound, and the webs are directed to a bonding and calibration nip 7 formed by two rolls. The webs are bonded in this nip 7. In the middle web 5 there is formed by pressing by rolls 8 a surface pattern by pressing the web 5 in a dry state so that permanent deformations are formed therein. By dry web is meant here the normal moisture content of a web coming from a storage or production roll 2, i.e. the web supply moisture content, which is usually below 10%, and in general within the range 3-12%. Also, no warming or heating of the web is used in the forming of the pattern. The surface pattern is most preferably a three-dimensional pattern, for example a honeycomb shaped pattern, in which case the strength of the web in the fiber direction and in the transverse direction is, with respect to the pattern, equally good, contrary to the two-dimensional flute pattern in corrugated board. The liner webs 4 and 6 are taken to the gluing rolls 9-12. Of these rolls, the roll 9, 10 on the outside of the liner web 4, 6 is the backing roll, and the adhesive is applied to the inner surfaces of the liner webs 4, 6 by means of the surface of the applicator roll 11, 12. The liner webs 4, 6 treated with the adhesive are then taken together with the deformed middle web 5 to the bonding nip, where they bond together, and at the same time the thickness of the board is calibrated by pressing with the rolls. In this manner the forming of the product and the bonding of the webs can be carried out in one step, together with calibration of the board thickness. The bonding nip 7 at the same time serves as the pulling nip for the webs. After the bonding the product can, when necessary be dried using a dryer 13, if the adhesive used requires this. Even other reacting methods can be used for the hardening of the adhesive, depending on the type of adhesive used.

The intention is, by means of the invention, to manufacture board for scanty-resource consumer packages, i.e. the aim is, with the help of the board according to the invention, to reduce the amount of raw material consumed for packaging. This board is a laminated box board having a typical total grammage of 80-500 g/m². The thickness of the product is typically 0.5-1.5 mm, and so it can be easily printed on by various printing methods. The manufacture is based on a process wherein dry fiber webs are bonded together by gluing to form a two- or multilayer material combination. The invention is based on mechanical processing of the middle-layer web in a dry state so that permanent deformations are formed therein. The processing is preferably carried out immediately before the gluing of the middle-layer web, on one or both of its sides, to a top-, bottom- or middle-laser web. The adhesive is spread as a continuous layer on both or one of the sides of the undeformed web; this further increases the strength of the product. The adhesive may also be spread on a deformed surface, on either one or both sides. Two or more different adhesives may be used in the same product. The bonding of the webs takes place in the nip, where the final thickness of the board product is determined and equalized. With water-based adhesives, several nips are used.

The partial webs may be raw webs or processed webs having a grammage of 30-200 g/m². The webs used may be coated and/or calendered processed webs, dr combination webs coated in various ways or comprising films. A middle-layer web may even be soft-tissue paper, if the desired strength properties are achieved with it. One or more of the webs may be of a polymer material or metal film instead of fiber webs.

Before the gluing, the liner webs 4,6 may be treated in the same process line, for example, by patterning. In the above example, the patterning of the surface web 4 is carried out mechanically by the embossing technique in nip 14. Furthermore, a web or webs can be coated with, for example, a barrier material. In the example this treatment is carried out on one of the liner webs in nip 15. This treatment can be carried out using functional barrier coating materials or varnishes or adhesives by attaching a film of the desired material to the web surface.

By “barrier coating” is meant here a treatment by means of which the product is rendered impermeable to liquid, fat, water vapor or gas. The spreading or attaching of the treatment material is known per se in the art, and there are several suitable methods.

One essential characteristic of the invention is that it is possible easily to attach to the product reinforcement tapes, as well as information processing elements such as magnetic tapes, foils comprising resonant identification circuits, identification chips, or other passive or active data processing elements on the basis of which packages made from the board can be identified or the manufacture and use of the packages can be controlled. The reinforcement or magnetic tape may be fed from a reel 16 to the bonding nip 7, and additional equipment of other types may be introduced using suitable feeder means 17 either to the nip or onto the surface of a web that has been treated with adhesive.

More detailed information on the manufacture of board and the uses of various board types can be found in FI patent application 20001799.

The adhesive is applied to the surface of undeformed an web, i.e. onto the surface of liner or middle layers, over the entire surface area. Adhesive can also be applied to a deformed surface. In this manner it can be ensured that all of the deformed points of a middle layer adhere, and at the same time, when drying, the adhesive reinforces the product. Depending on the type of adhesive, adhesive is applied in an amount of approx. 1-30, preferably approx. 2-15 g/m² per web to be glued per seam, measured as solids of the adhesive, and thus the amount applied is suitable for, for example, film transfer application. In itself, the adhesive can be applied in any manner, and some examples of the application methods include spray application, screen application, press application and jet application. The application temperature of hot melt adhesives is typically within the range 90-250° C. The adhesive may also be applied directly at the bonding nip 7 according to arrow 18. The essential point is that there will be a continuous layer of adhesive on the web surface so that the product will be strong and complete bonding of the middle layer is ensured. The adhesive must therefore have such a viscosity that it can be applied as a sufficiently thick layer by means of the application device available. In general the upper limit of the dynamic viscosity of an aqueous dispersion or solution adhesive is approximately 1500 mPas, preferably approximately 1200 mPas, at a solids content of approximately 50% and at room temperature (18-22° C.).

The adhesive can also be used for affecting the properties of the product, and for example ESD shielding (controlled discharge of the electric field) can thus also be carried out in connection with the gluing. Such a shield is important, since conductive polymers in general do not withstand alkaline conditions. If the adhesive is applied as a foam, it fills the cavities in the product and increases in particular its compressive strength.

Examples that can be cited of usable adhesives include the above-mentioned starch-based dispersions, solution adhesives and hot melt adhesives. Starch-based adhesives are advantageous even as such, since products treated with them are easy to recycle. They are biodegradable. It is essential of the adhesives to be used in the invention that they can be prepared so as to have a high solids content. According to the invention, the solids content of the adhesive applied to the board layers to be bonded together is at least 45% by weight (45-100% by weight); with dispersions and solution adhesives solids contents of 45-85% are aimed at. In hot melt adhesives the proportion of solids may be up to 100% by weight. The adhesives are stable also when their pH is below 7.

By means of a high solids content it is possible to reduce the amount of heating energy required for the drying of the glued board product. The aim is that the desired strength is achieved immediately upon the gluing. At a high solids content, as in the case of hot melt adhesives, additional heating is not needed after the application of the adhesive. When so desired, the webs can be preheated before the application of the adhesive.

The patterning of the middle layer 5 is carried out on a dry web by pressing the web so that permanent deformations are formed in the web. It would be advantageous for the web surface to remain unbroken, whereby the best strength is achieved. The patterning of the web is carried out in a dry state, since if a moistened web were used the web would require drying, which would require cost-increasing drying energy and efficient drying apparatus, and additionally during the drying of the web its deformations would affect the patterning and the web dimensions, since a damp fiber web shrinks considerably during drying. For this same reason it is highly preferable that the amount of water present in the adhesive is as low as possible.

By means of adhesives according to the invention, the after-bending typical of glued multilayer fiber products can be eliminated.

By “solids content” is meant the amount of material remaining of the adhesive composition after the water has been evaporated from the adhesive composition. As solids are calculated the biopolymer constituting the actual bonding agent, i.e. in this case the starch derivative, possibly its plasticizer, as well as dispersion auxiliaries and additives, such as protective colloids, cross-linking agents, surfactants, waxes, etc.

The various adhesive options will be examined in greater detail below.

As was already noted above, in the manufacture of the board product according to the invention, the problem involved with the dextrin adhesives known from the manufacture of other products is poor spreading, which is a consequence of the high viscosity of the adhesive. The problem becomes emphasized especially when the adhesive amounts to be applied are small. The adhesives used in the present invention are starch derivatives that are formulated into high solids content compositions, dispersions, solutions, or hot melt adhesives.

Starch-based dispersions are described in FI patent publication 105 566, the content of which is incorporated into this application by reference. The said patent discloses a method by which it is possible to prepare, for example, dispersions of starch derivatives with minimal use of water. According to the method there is first formed a mixture made up of a starch derivative or a similar biopolymer, a plasticizer of the said biopolymer, dispersion auxiliaries and water; the mixture is heated to produce a paste-like composition, whereafter it is diluted in a minimal amount of water to produce a stable dispersion.

The starch-based component of the dispersion may be a starch ester, starch ether, starch mixed ester/ether or grafted starch, prepared from native starch, hydrolyzed starch, oxidized starch, cross-linked starch or gelatinized starch. The starch for its part may be based on any native starch having an amylose concentration of 0-100% and amylopectin concentration of 100-0%. Thus the starch may be derived from barley, potato, wheat, oats, peas, corn, tapioca, sago, rice or a similar tuber or grain.

Especially the starch derivative is based on products prepared from the said native starches by oxidation, hydrolyzation, cross-linking, cationation, grafting, etherification or esterification.

It has been found preferable to use a starch-based component derived from an ester formed from starch and one or more aliphatic C₂₋₂₄ carboxylic acids. The carboxylic acid component of such an ester may in this case be derived from a lower alkanic acid, such as acetic acid, propionic acid or butyric acid, or mixtures of these. However, the carboxylic acid component may also be derived from a natural saturated or unsaturated fatty acid. Examples of these include palmitic acid, stearic acid, oleic acid, linolic acid, and mixtures of these. The ester may also be composed of both long-chain and short-chain carboxylic acid components. One example is a mixed ester of acetate and stearate. It also possible to use for the formation of the ester, in a known manner, alongside acids, corresponding acid anhydrides, as well as acid chlorides and other similar reactive acid derivatives.

The preparation of the starch fatty acid esters is carried out, for example, as disclosed in the following publications in the field: Wolff, I. A., Olds, D. W. and Hilbert, G. E., The acylation of Corn Starch, Amylose and Amylopectin, J. Amer. Chem. Soc. 73 (1952) 346-349 and Gros, A. T. and Feuge, R. O., Properties of Fatty Acid Esters of Amylose, J. Amer. Oil Chemists' Soc 39 (1962) 19-24.

Especially advantageous adhesives are obtained from starch acetates. These can be prepared by allowing the starch to react with acetanhydride in the presence of a catalyst. The catalyst used is, for example, 50% sodium hydroxide. Even other acetate preparation methods disclosed in the literature in the field are suitable for the preparation of starch acetate. Starch acetates of different degrees of substitution can be prepared by varying the amount of the acetic acid anhydride, the amount of the base used as a catalyst, and the reaction time.

According to one preferred embodiment, the starch component is an esterified starch, most preferably a starch acetate, having a substitution degree of 0.5-3, preferably 1.5-3, and most suitably 2-3. Especially preferably, for example, enzymatically hydrolyzed barley starch is used for the preparation of the starch esters.

According to another preferred embodiment, the starch component is a hydroxyalkylated starch or an ester thereof. In this case, a hydroxypropyl starch having a molar substitution degree at maximum 1.4, preferably at maximum 1, and hydroxypropyl starch esters having molar substitution degrees at maximum 1.4, preferably at maximum 1, and especially preferably 0.1-0.8, and a substitution degree at minimum, 2, preferably 2.5-3, are especially preferable.

In general, a starch ester dispersion regarded as preferable contains 100 parts by weight of a starch ester, 5-50 parts by weight of a protective colloid, 10-200 parts by weight of a softener, 0.1-10 parts by weight of a surfactant, and approx. 120-270 parts by weight of water, the amount of water being selected so that the solids content in the dispersion is at least 45% by weight, i.e. the amount of water is at maximum equal to or slightly higher than that of the other components in total.

According to an especially preferred embodiment, the dispersion is prepared by mixing
100 parts by weight of a starch ester, 5-50 parts by weight of a protective colloid, and 10-200 parts by weight of a softener with 70-120 parts by weight of water mixed with 0.01-10 parts by weight of a surfactant, in order to form a starch ester mixture,
after initial mixing, the temperature of the mixture is raised to 40-90° C., and the mixing is continued until a white paste-like composition is obtained, and
50-150 parts by weight of water is added to the said composition while the temperature of the composition is allowed to drop to room temperature.

After the dispersing, the dispersion is, when so desired, homogenized in a manner known per se in order to stabilize it. The homogenization may, for example, be effected by means of a pressure homogenizer. By homogenization the particle size can be reduced by 50-100% and thereby the stability of the dispersion can be further improved. The dispersions according to the invention are stable for several weeks, even months.

According to one preferred embodiment of the present invention, the technical success of the gluing presupposes that the viscosity of the dispersion formulation at a solids content of, for example, 45-50% is, for example, 500-1200 mPas/18-22° C. In this case the adhesive can be applied by the methods described in the present invention, in a wet state, 10-12 g/m², which corresponds to a dose of 5-6 g of dry adhesive. The adhesive joint holds immediately (100% fiber tear) while the board is still most. After water has left the board, the holding of the adhesive joint increases while the stiffness of the board increases.

In addition to dispersions of starch derivatives, solution adhesives and hot melt adhesives can be used as the adhesive. By “solution adhesive” is meant in this context an adhesive wherein the starch derivative is at room temperature dissolved in the medium of the composition (i.e. primarily water). In order for a solution adhesive to be usable in an application according to the invention, the viscosity of the composition must be so low at the application temperature of the adhesive that it can be applied by the available technique at a solids content of over 45% by weight.

In addition to the above derivatives, transglycosylation products of starch or starch derivatives can be used as the starch-based components in both dispersions and solution adhesives.

The term “transglycosylation products” is used for substances obtained by causing a native starch or starch derivative, such as starch ester, to react with various alcohols, such as methanol, butanol, ethylene glycol, propylene glycol and glycerol in acid conditions. The products formed may also be called alkyl glucoside or hydroxyalkyl glucoside compounds.

Glycerol-O-1-glucopyranosyl ethers prepared from starch by transglycosylation can be prepared by the process according to a parallel application in the name of the Technical Research Centre of Finland (VTT). There is obtained, for example, a mixture composed of 1-, 2- 1,2-, 1,3 and 1,2,3-O-1-glucopyranosyl ethers of glycerol.

The low molecular weight of the transglycosylation product raises the solids concentration of the composition without increasing its viscosity, and its good adherence properties give the adhesive good adhesiveness. A holding adhesive joint is obtained without heating. The viscosity of aqueous solutions of transglycolysation products will in certain cases not increase significantly until at a concentration of 80%.

From transglycosylation products (this means transglycosylation products formed from both native starch and from starch derivatives) it is also possible to prepare hot melt adhesives by plasticizing them with a softener. Advantageous solution adhesives are obtained from a starch acetate having a sufficiently high degree of substitution, preferably over 1.5. It is also possible to use water-soluble mixed esters formed by higher and lower alkanic acids and starch, as well as starch ethers and mixed esters of starch, such as hydroxypropyl starch. By varying the conditions and reaction time of the transglycolysation reaction as well as the amounts of reagents it is possible to affect the molecular weight and acetyl content of the product, which makes it possible to modify the properties of the adhesive (viscosity, adhesiveness, melting point, hydrophobicity).

Good gluing results are obtained, for example, when two starch acetate transglycosylation products of two different molecular weights are mixed, one giving the adhesive stiffness and the other adhesiveness. The mixing of two products having similar structures also provides the advantage that there will be no problems of compatibility between the components, which problems are seen as turbidity of the adhesive and have a deteriorating effect on the gluing results. Especially advantageous gluing results are also achieved by using a transglycosylation product prepared from starch and glycerol. In hot melt adhesives there are generally used transglycosylation products having a molecular weight of 5,000-250,000, preferably approximately 10,000-100,000.

As an example of the blending of transglycolysation products with known adhesives reference is made to the fact that by blending a cold water soluble starch (DL-20) and a tg product (250 TGG1) it is possible to prepare an adhesive having a solids content up to over 60% and a viscosity nearly 50% lower than that of a dextrin adhesive. The said starch product is an excellent adhesive; the use of the product in embodiments according to the invention is, however, limited by the high viscosity of its aqueous solution.

Respectively, when dextrin and 250 TGG1 were blended at a ratio of 1:1, the viscosity of the commercial dextrin adhesive dropped by 96%. This test also showed that transglycosylation products of starch and polyols can be used for modifying dextrin adhesives that are fully known per se.

As to the structure of the starch acetate transglycosylation product and its properties such as biodegradability, the stability/degradation of the acetate group at the C6 carbon can be affected by controlling the reaction. The acetate group at the C6 carbon lowers enzymatic biodegradability.

Additives generally used in hot melt adhesives can be used, but good adhesion is achieved even otherwise.

The hot melt adhesive used in the invention can be prepared from starch acetate in one process, in which case the transglycosylation reaction of starch acetate is first carried out by means of ethylene glycol, any excess ethylene glycol is removed by evaporation, and the desired amount of softener is added and mixed. The grade of the polymer formed can be affected by means of the acetylation degree of the product. Depending on the polymerization method, the products have different melting points and glass transition temperatures. Products of low melting points can be used as such in hot melt adhesives without external softeners. Products of higher melting points require softening.

Hot melt adhesives can also be prepared directly from starch acetate and similar starch derivatives, for example in the manner described in EP application publication 0 603 768 A1. However, the products described above yield a more advantageous result. By the use of derivatives having a relatively low molecular weight for lower melting point products, a hot melt adhesive can be prepared by simple melting and no extrusion is required, although it can be used.

The glucose polymer used in hot melt adhesives is characterized in that the glucose polymer contains at least one, preferably 2-3, ester substituents, such as acetyl groups, per one anhydroglucose unit. Additionally there may be a PCL or PLA polymer linked to the anhydroglucose unit.

According to one preferred hot melt formulation, the viscosity of the starch-based hot melt adhesive is 1200 mPas/150° C. and 1610 mPas/125° C. measured at a shear rate of 100 rpm. The viscosity measured for the closest corresponding commercial polyolefin-based hot melt adhesive was 4700 mPas/150° C., the shear rate being 100 rpm.

By the use of transglycosylation products, according to the invention, of starch acetate and polyol it is possible to prepare hot melt adhesives the applicability of which is excellent within a wide temperature range of 90-180° C.

The following non-restrictive examples will illustrate the invention:

### EXAMPLE 1

Dispersion Adhesive

A dispersion adhesive was prepared by the method according to Example 1 of Patent FI 105566 in a 250 liter Drais reactor. 35.00 kg of hydroxypropyl starch acetate (COHPOL C6LL100, Batch 5C23, solids content 97.1%), 2.63 kg of Mowiol 40-88, 26.25 kg of triacetin, and 24.49 kg of water are fed into the reactor. The mixture is stirred for 30 min at 20° C. in order to homogenize the reaction mixture. Thereafter the mixture is heated in the course of half an hour to 95-100° C. and is kept at that temperature for 3 h. 8.75 kg water is added to the reaction mixture while the temperature is allowed to drop to 70° C. The adding is carried out in the course of approx. 1 hour.

After hot dilution, the mixture is stirred for another hour, and the reaction mixture is allowed to cool to 50-60° C., at which 8.75 kg of water is added in the course of approx. one hour. Thereupon the solids content of the dispersion is approx. 60%.

The mixture is cooled to <40° C., and the dispersion is diluted to its final concentration by adding gradually 9.88 kg of water. The solids content of the dispersion is approx. 55% and its Brookfield viscosity at 20° C. is 1825 cP.

The dispersion can be diluted with water. The viscosity of a dispersion having a solids content of 50.6% is 650 cP measured in the same conditions as above.

### EXAMPLE 2A

Hot Melt Adhesive

Generally the hot melt adhesives were prepared by mixing a transglycosylation product of starch acetate and ethylene glycol (the preparation of this product is described in greater detail in Example 9 of the parallel patent application entitled “Uudet tärkkelysjohdannaiset ja menetelmä niiden valmistamiseksi” (Novel starch derivatives and a method for their preparation) of the Technical Research Centre of Finland, VTT) with a softener and by melting the mixture at 130-140° C. until the melt was completely clear. VTT's patent application was filed on Feb. 15, 2002. Table I describes various hot melt adhesive formulations the adhesive properties of which were investigated in the preparation of the board product of FI patent application 20001799.

TABLE 1a

| | Transglycosylation | | | |
|---|---|---|---|---|
| Adhesive | product of starch acetate | Softener | Additives | Observations |
| 1 | 7TG5, Mw 95200, | Triethyl citrate | | When cooled, a bright, |
| | Mn 9800, Mw/Mn 9.7 | 0.7 part by weight | | hard and rather viscous |
| | 1.0 part by weight | | | adhesive |
| 2 | 7TG10, Mw 74000, | Triethyl citrate | | When cooled, a bright, |
| | Mn 12200, Mw/Mn 6.0 | 1.3 parts by weight | | rather hard and viscous |
| | 1.0 part by weight + | | | adhesive |
| | 7TG9, Mw 17700, | | | When hot, well flowing |
| | Mn 7000, Mw/Mn 2.5 | | | and spreading |
| | 1.0 part by weight | | | |
| 3 | 7TG7, Mw 13300, | Triethyl citrate | | When cooled, a bright, |
| | Mn 6500, Mw/Mn 2.0 | 1.3 parts by weight | | rather soft and viscous |
| | 1.0 part by weight + | | | adhesive. |
| | 7TG11, Mw 11700, | | | A good film former |
| | Mn 6400, Mw/Mn 1.9 | | | |
| | 1.0 part by weight | | | |
| 4 | 7TG9, Mw 17700, | Triethyl citrate | | When cooled, bright, soft |
| | Mn 7000, Mw/Mn 2.5 | 2.25 parts by weight | | and slightly sticker-like |
| | 1.0 part by weight + | | | |
| | 250TG3 (Example 10, | | | |
| | Patent Application ???) | | | |
| | 4.0 parts by weight | | | |
| 5 | 7TG7, Mw 13300, | Triethyl citrate | Sylvatac 80 | When hot, bright; |
| | Mn 6500, Mw/Mn 2.0 | 1.3 parts by weight | 0.1 part by weight | when cooled, a turbid, |
| | 1.9 parts by weight | | | rather hard adhesive |

### EXAMPLE 2B

Preparation of Hot Melt Adhesive in One Batch Process

Starch acetate (C6N100 EP, Batch 5C48-49, 34.1 kg) was introduced into the reactor and stirring was switched on (stirrer/homogenizer 85 rpm/1500 rpm). Ethylene glycol (32.2 kg) mixed with 69% of a 93% sulfuric acid was added. The reaction mixture was stirred for 30 min, whereafter vacuum was switched on and the heating of the reactor to 110-120° C. was started, at which temperature the reaction mixture was maintained for 1 h. Thereafter the sulfuric acid present in the reaction mixture was neutralized with calcium carbonate and the evaporation of excess ethylene glycol with vacuum was started. When the ethylene glycol had been evaporated, the vacuum pump was switched off, and 26 kg of triethyl citrate was added to the molten mix and was mixed into a smooth melt at 110-120° C.

The test showed that the manufacture of a hot melt adhesive is possible as a continuation of the transglycosylation reaction.

### EXAMPLE 2C

Hot Melt Adhesives Containing Starch Acetate Polymers

Hot melt adhesives, the formulations of which are described in Table 1a. were prepared by the same method as in Example 2A.

TABLE 1b
Polymer containing hot melt adhesive formulations

| | Transglycosylation | | | |
|---|---|---|---|---|
| | product of | | | |
| Adhesive | starch acetate^{1,4} | Starch acetate¹ | Softener | Observation |
| 1 | Mw: 27,000 | Starch acetate² | Triethyl citrate | Good film |
| | 48.1% | 12.03% | 39.8% | formation |
| | | | | Short open time |
| 2 | Mw: 27,000 | Hydroxy propyl | Triethyl citrate | Excellent film |
| | 29.4% | starch acetate³ | 41.1% | formation |
| | | MS_{HPS}: 0.4 | | |
| | | DS_{Acet} 2.8 | | |
| | | 29.4% | | Short open time |
| 3 | Mw: 27,000 | Hydroxy propyl | Triethyl citrate | Excellent film |
| | 27.8% | starch acetate³ | 44.4% | formation |
| | | MS_{HPS}: 0.4 | | |
| | | DS_{Acet} 2.8 | | |
| | | 27.8% | | Longer open |
| | | | | time |

¹Starch acetates were prepared according the patent FI 107386
²Starch acetate prepared from amylose rich starch (HYLON VII)
³Hydroxypropylated starch acetate prepared from amylose rich starch (HYLON VII)
⁴Starch acetate were prepared from potato starch, DS_{Acet} 2.8

Hot melts were applied to a 110 g/m² liner to which a deformed 70 g/m² craft paper was bonded immediately or after few second. The gluing result was a 100% fiber tear. The adhesive in test 3 has longer open time than the two other adhesives.

### EXAMPLE 2D

Preparation of Hot Melt Adhesive Composition Containing Starch Acetate Polymer in One Batch Process

Transglycosylation of native potato starch acetate was carried out by using the process, described in Example 2B. After neutralization of sulfuric acid catalyst by calcium carbonate 1.6 part by weight of triethyl citrate, calculated from the amount of initial potato starch triacetate, was added to the molten mix. Excess ethylene glycol was evaporated at 60-80° C. with vacuum. When the ethylene glycol had been evaporated, the vacuum pump was witched off, and 1 part by weight of hydroxy propyl starch acetate (same as in Example 2C) calculated from the amount of initial potato starch acetate was added to the molten mix. Mixing was continued into a homogenous, highly viscous melt at 110-120° C. The adhesive has excellent cohesion and can be therefore stretch out to 100 micron film or even less.

### EXAMPLE 3

Solution Adhesive

High solids content solution adhesive compositions were prepared by mixing a hydroxypropyl derivative (COHPOL DL 20) of an enzymatically hydrolyzed starch with the transglycosylation product (polyol, 250TGG1-02) according to Example 4 of the parallel patent application entitled “Uudet tärkkelyspohjaiset liirat” (Novel starch-based adhesives) of the Technical Research Centre of Finland (VTT) in the proportions indicated in Table 2. VTT's patent application was filed on Feb. 15, 2002.

TABLE 2
Starch-based solution adhesive compositions

| | | Percentage | | | | |
|---|---|---|---|---|---|---|
| | Starch | of solid | | | | Viscosity |
| Adhesive type | product | content | Polyol | Percentage | Solids | at 20° C. |
| Solution | DL 20 | 50.0 | 250TGGl-02 | 50.0 | 52% | 5600 mPas |
| adhesive | | | | | | |
| Solution | DL 20 | 81.25 | 250TGGl-02 | 18.75 | 57% | 34000 mPas |
| adhesive | | | | | | |

By the use of polyol it is possible to lower the water content of the adhesive composition and, on the other hand, to lower the viscosity of the adhesive when necessary.

A continuous layer of a 57% solution adhesive was applied to a 110 g/m² liner, to which a deformed 70 g/m² kraft paper was immediately bonded. The gluing result was a 100% fiber tear.

### EXAMPLE 4

The transverse stiffness measured (according to DIN 53121) for the 3-layer board described in FI patent application 20001799 was 80 mNm, which is of the level corresponding to that of E-fluted board at the same grammage 335 g/m², and 175% higher than that of folding board at the said grammage. The said board is made up of 110 g/m² kraft liners at the top and bottom and of 70 g/m² kraft paper in the middle. The layers were bonded with a starch-based hot melt adhesive that was applied using a nozzle, to both the bottom and the top. The adhesive used in the example was made from starch acetate. The adhesive can also be applied to the middle layer or to both of the webs to be laminated. After the application of the adhesive the webs to be laminated are bonded either in one or in several separate lamination nips.

### EXAMPLE 5

A transverse stiffness (DIN 53121) of 70 mNm was attained with the starch dispersion glued 3-layer board according to FI patent application 20001799. This is of the same level as the stiffness of corresponding E-fluted board and 270% higher than that of folding board. In this, the glued layers were a 115 g/m² kraft liner at the top, and 70 g/m² kraft papers in the middle and at the bottom, the total grammage being 290 g/m². The adhesive was applied before lamination both to the bottom and the top by roll application, wherein any excess adhesive is scraped off before actual application to the web. The adhesive can also be applied to the middle web or both webs to be laminated. After the application of the adhesive the webs to be laminated are bonded either in one or in several separate lamination nips. After the lamination nip the product was not dried in a separate drying unit, but it is also possible to carry out drying. The solids content of the starch dispersion adhesive was 51%.

### EXAMPLE 6

The example examines the viscosities of aqueous solutions of glycerol-O-1-glucopyranosyl (250 TGG-1) as a function of the solids content, and the viscosities of adhesives prepared therefrom are compared as a function of the solids content at a shear rate of 750 rpm.
250TGG glycerol glucose ethers

DL20 modified starch

TABLE 3

Viscosity
measurement

| Adhesive | Shear | | |
|---|---|---|---|
| concentration, | rate, | Viscosity, | |
| 250TGG1 | rpm | mPas | DL20 |
| 40% | 750 | 10 | 1000 |
| 50% | 750 | 10 | 3140 |
| 60% | 750 | 10 | — |
| 70% | 750 | 10 | — |
| 80% | 750 | 1000 | — |

TABLE 4

| | | | Mass | | | |
|---|---|---|---|---|---|---|
| | Component | Component | ratio | Solids | | |
| Adhesive | A | B | A:B | content | rpm | mPas |
| 1 | Dextrin | 0 | 1:0 | 57 | 750 | 3540 |
| 2 | DL-20 | 0 | 1:0 | 40 | 750 | 1000 |
| 3 | Dextrin | 250TGG | 1:1 | 57 | 750 | 150 |
| 4 | DL-20 | 250TGG | 1:1 | 57 | 750 | 1280 |
| 5 | DL-20 | 250TGG | 1:1 | 62 | 750 | 2020 |

1. A method for manufacturing a board product made up of at least two layers, according to which method board webs forming the layers are bonded together by gluing, at least one of the webs being treated mechanically by compression so that permanent deformations protecting from the web surface are formed in the web surface, characterized in that
the layers are bonded together by using a starch-based adhesive that contains a starch derivative, which is applied at a solids content of over 45% to the layers to be bonded.

2. The method according to claim 1, characterized in that the solids content of the adhesive is 50-85% by weight.

3. The method according to claim 2, characterized in that the starch-based adhesive used is a dispersion or solution containing a starch derivative.

4. The method according to claim 1, characterized in that the solids content of the adhesive is over 85% by weight, the adhesive used being a hot melt adhesive.

5. The method according to claim 1, characterized in that the adhesive is used in the same product together with a second adhesive.

6. The method according to claim 5, characterized in that the second adhesive comprises an adhesive of another type.

7. The method according to claim 1, characterized in that the starch-based adhesive used is a composition that contains a starch ester, starch ether, starch mixed ester/ether, and/or grafted starch or a similar starch component prepared from native starch, hydrolyzed starch, oxidized starch, cross-linked starch, gelatinized starch, or a hydroxyalkylated starch or an ester thereof.

8. The method according to claim 1, characterized in that the starch-based adhesive used is a composition that contains a transglycosylation product of a starch or a starch derivative.

9. The method according to claim 1, characterized in that the adhesive is applied to those surfaces of untreated webs that come against the treated web, over the area of the entire surface in order to improve the barrier properties of the product.

10. The method according to claim 1, characterized in that the adhesive is applied simultaneously to the deformed surface.

11. The method according to claim 1, characterized in that after the application of the adhesive the webs are bonded in one or several bonding nips, where the webs of the board product are pressed together so that their thickness is standardized.

12. The method according to claim 11, characterized in that at least three webs are bonded together simultaneously at the bonding nip.

13. A board product comprising at least two layers glued to each other, at least one of the layers being planar, and at least one of the layers being processed mechanically so that the material has permanent three-dimensional deformations, characterized in that at least two layers are bonded together by means of a starch-based adhesive that contains a starch derivative.

14. The board product according to claim 13, characterized in that the starch derivative comprises a starch ester, starch ether, starch mixed ester/ether and/or grafted starch or similar starch component prepared from native starch, hydrolyzed starch, oxidized starch, cross-linked starch, cationic starch or gelatinized starch, or a hydroxyalkylated starch or an ester thereof, or a transglycosylation product of a starch or a starch derivative.

15. The board product according to claim 13, characterized in that in at least one planar layer the surface facing the mechanically modified layer is treated with adhesive over its entire area.

16. The board product according to claim 15, characterized in that the product comprises three layers and the deformed layer is between the planar layers.
